(19) United States
(12) Patent Application Publication
(10) Pub. No.: US 2004/0014385 A1
(43) Pub. Date: Jan. 22, 2004

(54) Storm resistant roofing material

(76) Inventors: Gerald G. Greaves JR., Granville, OH (US); Carla A. Miller, Newark, OH (US)

Correspondence Address: OWENS CORNING, 2790 COLUMBUS ROAD, GRANVILLE, OH, 43023, US

(21) Appl. No.: 10/335,050

(22) Filed: Dec. 31, 2002

Related U.S. Application Data
(63) Continuation-in-part of application No. 09/223,670, filed on Dec. 30, 1998, now Pat. No. 6,426,309.

(51) Int. Cl. B32B 5/02; B32B 27/04; B32B 27/12; B32B 1/00; D06N 7/04; B32B 27/02; B05D 1/12; B05D 1/24; D03D 15/00; D04H 1/00; D04H 3/00; D04H 5/00; D04H 13/00; B32B 5/26; B32B 5/06

(52) U.S. Cl. 442/148; 442/104; 442/164; 442/167; 442/170; 442/171; 442/364; 442/381; 442/389; 442/390; 428/142; 427/186; 442/188

(57) ABSTRACT

A roofing material includes a thermoplastic substrate coated with an asphalt coating, a protective coating adhered to the upper surface of the asphalt coating, and a surface layer of granules adhered to the protective coating. The asphalt coating includes an upper surface that is positioned above the substrate when the roofing material is installed on a roof. The substrate comprises materials having an ultimate tensile elongation of greater than about six percent.

### CROSS REFERENCE TO RELATED APPLICATION

This application is a continuation-in-part of U.S. application Ser. No. 09/223,670, filed Dec. 12, 1998.

### TECHNICAL FIELD AND INDUSTRIAL APPLICABILITY OF THE INVENTION

This invention relates to asphalt-based roofing materials, and in particular to a roofing material having improved durability and impact resistance to withstand the destructive forces of storms.

### BACKGROUND OF THE INVENTION

Asphalt-based roofing materials, such as roofing shingles, roll roofing and commercial roofing, are frequently installed on roofs of buildings to provide protection from the elements. Typically, the roofing material is constructed of a substrate such as a glass fiber mat-or an organic felt, an asphalt coating on the substrate, and a surface layer of granules embedded in the asphalt coating for aesthetic purposes and to provide a protective layer for the asphalt.

Typical roofing material construction is suitable under most circumstances. However, sometimes a roofing material is subjected to environmental conditions that may damage the roofing material. For example, severe storms are responsible for billions of dollars in damage to roofing materials every year. During such storms, hailstones may impact the roofing material, which may cause tears or punctures in the roofing material. The hailstone impact may also cause an immediate loss of some granules from the impacted areas of the roofing material, and facilitate a further loss of granules from those areas over time. The loss of granules creates an unattractive appearance and leaves the asphalt coating in those areas unprotected from the degrading effects of the elements. Accordingly, there is a need for a roofing material having an improved ability to withstand the destructive forces of storms.

The prior art does not adequately address the need for a storm resistant roofing material. For example, U.S. Pat. Nos. 5,380,552 and 5,516,573, both issued to George et al., disclose a method of purportedly improving the adhesion of granules to a roofing shingle, by spraying a thin stream of a low viscosity adhesive to cover 50-75% of the surface of the asphalt coating before applying the granules. The patents teach that granule loss is caused by moisture disrupting the bond between the granule and the asphalt coating. There is no suggestion that granule loss may be related to changes in the asphalt coating over time, or that sufficiently covering the asphalt coating with the adhesive may reduce these changes and the resultant granule loss.

It is known to apply a surface coating onto a roof after the roofing shingles have been installed to protect the shingles from granule loss and other damage. Unfortunately, surface coatings require additional labor to apply after the roofing shingles have been installed, they are relatively expensive, and they may appearance issues, or create safety problems by producing a slick roof.

Several patents disclose roofing materials constructed with multiple substrates. For example, U.S. Pat. No. 5,326,797, issued to Zimmerman et al., discloses a roofing shingle including a top mat of glass fibers and a bottom mat of polyester. The patent is related to a fire-resistant shingle, and there is no mention of improved impact resistance. Also, there is no suggestion of improved bonding between the polyester mat and the asphalt coating.

U.S. Pat. No. 5,571,596, issued to Johnson, discloses a roofing shingle including an upper layer of directional fiber such as Kevlar fabric, a middle layer of fibrous mat material such as glass fiber mat, and a lower layer of directional fiber such as E-glass fabric. The upper fiber layer is described as being important to shield the shingle from hail impact damage. The lower layer of E-glass fabric is not effective for improving the impact resistance of the shingle.

U.S. Pat. No. 5,822,943, issued to Frankoski et al., discloses an asphalt-coated roofing shingle including a scrim and a mat. The scrim is bonded to the mat with adhesive; there is no suggestion of improved bonding between the scrim and the asphalt coating. A scrim is not very effective for improving the impact resistance of a roofing shingle.

It is also known to manufacture roofing materials with rubber-modified asphalt. However, conventional rubber-modified asphalt shingles are not very effective in resisting impacts, and are more difficult to manufacture, handle, store and install than roofing materials made with conventional roofing asphalt. Accordingly, there is still a need for a roofing material having improved durability and impact resistance to better withstand the destructive forces of storms.

### SUMMARY OF THE INVENTION

The above objects as well as others not specifically enumerated are achieved by an asphalt-based roofing material according to the present invention. The roofing material preferably includes a thermoplastic substrate coated with an asphalt coating, a protective coating adhered to the upper surface of the asphalt coating, and a surface layer of granules adhered to the protective coating. The asphalt coating includes an upper surface that is positioned above the substrate when the roofing material is installed on a roof, and a lower region that is positioned below the substrate when the roofing material is installed on the roof. The substrate also preferably comprises materials having an ultimate tensile elongation of greater than about six percent. The combination of the thermoplastic substrate and the protective coating provides a roofing material having both improved durability and improved impact resistance. As a result, the roofing material is better able to withstand the destructive forces associated with storms. Additionally, such a construction may include a web applied to the underside of the shingle, preferably as described in commonly-assigned U.S. Pat. No. 6,228,785 to Miller et al, which is incorporated herein by reference in its entirety.

In another embodiment, the roofing material includes a portion that is normally exposed when the roofing material is installed on a roof, and comprises a thermoplastic substrate coated with an asphalt coating, a protective coating adhered to an upper surface of the asphalt coating, and a surface layer of granules adhered to the protective coating. The asphalt coating is positioned above the substrate when the roofing material is installed on a roof, and the substrate comprises materials having an ultimate tensile elongation of greater than about six percent. The protective coating is a continuous layer and covers at least about 80% of the upper surface of the asphalt coating in the exposed portion of the roofing material. At least a portion of the granules penetrate the asphalt coating, the protective coating provides a seal to prevent outside moisture from flowing around the granules to the asphalt coating, and the protective coating completely envelops a number of the granules within the range of from about 0.5% to about 6% of the total granules. Additionally, such a construction may include a web applied to the underside of the shingle, preferably as described in the Miller '785 patent.

The present invention also relates to a method of manufacturing an asphalt-based roofing material. The method includes the steps of coating a thermoplastic substrate with an asphalt coating, applying a protective coating to the upper surface of the asphalt coating, and applying a surface layer of granules to the protective coating. The asphalt coating includes an upper surface that is positioned above the substrate when the roofing material is installed on a roof, and a lower region that is positioned below the substrate when the roofing material is installed on the roof. The substrate comprises materials with an ultimate tensile elongation of greater than about six percent.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 is a schematic view in elevation of apparatus for manufacturing an asphalt-based roofing material according to the invention.

FIG. 2 is a perspective view of part of the manufacturing apparatus of FIG. 1, showing an applicator applying films of protective coating onto the upper surface of an asphalt-coated sheet.

FIG. 3 is a cross-sectional view of an alternate embodiment of an applicator applying a film of protective coating onto the upper surface of an asphalt-coated sheet.

FIG. 4 is an enlarged cross-sectional view of an asphalt-based roofing material according to the invention.

FIG. 5 is a further enlarged cross-sectional view of the upper portion of an asphalt-based roofing material according to the invention.

FIG. 6 is a perspective view of a prior art roofing shingle installed on a roof, showing a loss of granules after a period of time caused by impacts on the roofing shingle.

FIG. 7 is a perspective view of a roofing shingle according to the invention installed on a roof, showing substantially no granule loss over the same period of time after being impacted.

FIG. 8 is a top view of a sheet of roofing material manufactured with the apparatus of FIG. 1, showing the roofing material after being cut but before separation into roofing shingles.

FIG. 9 is a perspective view of several three-tab roofing shingles according to the invention installed on a roof.

FIG. 10 is a perspective view of a hip and ridge roofing shingle according to the invention installed on the ridge of a roof.

FIG. 11 is a perspective view of a laminated roofing shingle according to the invention.

### DETAILED DESCRIPTION AND PREFERRED EMBODIMENTS OF THE INVENTION

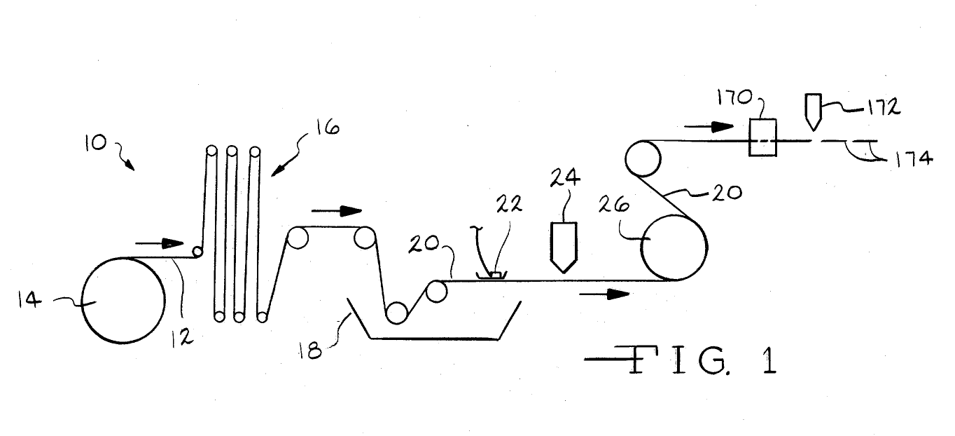

Referring now to the drawings, there is shown in FIG. 1 an apparatus 10 for manufacturing an asphalt-based roofing material according to the invention. The illustrated manufacturing process involves passing a continuous sheet 12 in a machine direction (indicated by the arrows) through a series of manufacturing operations. The sheet usually moves at a speed of at least about 200 feet/minute(61 meters/minute), and typically at a speed within the range of between about 450 feet/minute (137 meters/minute) and about 800 feet/minute (244 meters/minute). Although the invention is shown and described in terms of a continuous process, it should be understood that the invention can also be practiced in a batch process using discreet lengths of materials instead of continuous sheets.

In a first step of the manufacturing process, a continuous sheet 12 of substrate is payed out from a roll 14. The substrate 12 is positioned and bonded in such a manner, as to provide the roofing material with improved durability. One aspect of the improved durability is an improved impact resistance to a variety of impacts. The improved impact resistance eliminates the occurrence of punctures or tears in the roofing material caused by impacts, and thereby maintains the integrity of the roofing material. The roofing material retains its ability to protect the building from the elements so that, for example, water leaks are avoided.

A variety of different types of substrate 12 are suitable for use in the present invention. The material and structure of the substrate 12 are chosen so that the substrate 12 is effective to improve the impact resistance of the roofing material. Specifically, the substrate 12 is effective to dissipate the energy of an impact on the roofing material. Preferably, the material of the substrate 12 has good tensile flexure properties, so that it can dissipate the impact energy. A glass mat has limitations in making shingles with improved impact resistance because of the limited elongation properties of the mat. Also preferably, the structure of the substrate 12 is substantially continuous along its length and width so that it can transmit energy waves uninterrupted from the point of impact to the edges of the substrate 12.

Preferably, the substrate 12 is also a material which has components that can fuse to the asphalt coating by having a portion of the substrate 12 melt and intermingle with the asphalt coating. Thermoplastic polymer components are preferred for use in the substrate because they are capable of partially melting in contact with the hot asphalt coating. On the other hand, thermoset polymer components will not melt in contact with the coating. Preferably, the substrate 12 material is at least partially miscible with the asphalt coating.

Also preferably, the substrate 12 has the property that it can be cut cleanly and easily during the roofing material manufacturing process, such as when the sheet of roofing material is cut into shingles and when the tabs are cut in a shingle. The clean cutting means that no portions of the substrate material are seen protruding from the edges of the cut roofing material.

It is preferred that the substrate 12 does not substantially shrink in contact with the hot asphalt coating, thus providing total surface coverage. Also preferably, the material of the substrate has a coefficient of friction that prevents the roofing material from sliding off a roof during installation.

Some materials that may be suitable for use as the substrate include sheet web, wherein sheet web is defined as film, such as, for example, thermoplastic polyester, polyamide imide, glass reinforced nylon, and polybutylene terephthalate. A mixture of such materials may best provide the characteristics required by the present invention. Preferably, the substrate is polyester film, such as, for example, Mylar® film, manufactured by E. I. Du Pont De Nemours and Company. The substrate preferably has an average thickness within the range of from about 0.005 inches to about 0.030 inches, and has an ultimate tensile elongation of greater than about six percent. Preferably, tensile elongation is measured after aging the roofing material to simulate a period of time on a roof, such as within the range of from about 15 years to about 50 years. After simulated aging, tensile elongation is measured using a suitable test standard, such as ASTM D882. Preferably, the substrate further retains its tensile strength when processed at elevated temperatures, such as, for example, temperatures within the range of from about 375 degrees F. (190 degrees C.) to about 400 degrees F. (205 degrees C.). Although the preferred embodiment of the substrate is in the form of film, it is understood that satisfactory results may be achieved by a non-film substrate. In an alternative embodiment, the substrate also includes glass or other reinforcing fibers, in combination with other materials described herein, such as a wet-formed mat including polyester and glass fibers, and preferably a suitable binder.

During the manufacture of shingles, the sheet of substrate 12 is passed from the roll through an accumulator 16. The accumulator allows time for splicing one roll of substrate to another, during which time substrate 12 within the accumulator is fed to the manufacturing process so that the splicing does not interrupt manufacturing.

Next, the substrate 12 is passed through a coater 18 where asphalt coating is applied to the substrate 12. The asphalt coating can be applied in any suitable manner. In the illustrated embodiment, the substrate 12 is submerged in a supply of hot, melted asphalt coating to completely cover the upper and lower surfaces of the substrate 12 with the tacky asphalt coating. However, in other embodiments, the asphalt coating could be sprayed on, rolled on, or applied to the substrate 12 by other means, such as for example by using some sort of extrusion device or a doctor blade. Preferably, when a thermoplastic film is used as the substrate 12, a modified asphalt will be applied only to the upper surface of the substrate 12. Shingles having a modified asphalt lower surface may stick to an adjacent shingle when shingles are stacked or packaged in a bundle. Accordingly, the lower surface of the substrate 12 is preferably free of modified asphalt, and therefore the lower surface will not stick to adjacent shingles in a bundle. Alternatively, a different modified asphalt may be used for the lower surface to avoid sticking, or a coating or film may be applied to the bottom. Additionally, a web, as described in Miller may be applied to the lower surface.

The term “asphalt coating” means any type of bituminous material suitable for use on a roofing material, such as asphalt, tar, pitch, or mixtures thereof. The asphalt can be either manufactured asphalt produced by refining petroleum or naturally occurring asphalt. The asphalt coating can include various additives and/or modifiers, such as inorganic fillers or mineral stabilizers, organic materials such as polymers, recycled streams, or ground tire rubber. Preferably, the asphalt coating contains an asphalt and an inorganic filler or mineral stabilizer. Another aspect of the improved durability is a reduction in cracking and striation, which may be caused by hailstones during storms in addition to natural weathering. To improve the durability of the roofing material, the asphalt is also preferably modified with rubber or similar polymers.

The roofing material of the present invention is further provided with improved durability by the application of a protective coating to the upper surface of the asphalt coating. Another aspect of the improved durability is a reduction in the loss of granules. Such loss of granules may be caused by hailstones during storms, or by natural weathering. As shown in FIG. 1, the asphalt-coated sheet 20 is passed beneath an applicator 22, where a protective coating is applied to the upper surface of the asphalt coating. The sheet is then passed beneath granule dispensers 24 (only one of which is shown) for the application of granules to the protective coating. After the deposit of the granules, the sheet is turned around a slate drum 26 to press the granules into the asphalt coating and to temporarily invert the sheet. The sheet 20 of asphalt-based roofing material is again inverted, and then cooled by any suitable cooling apparatus 170, or allowed to cool at ambient temperature.

The sheet 20 of asphalt-based roofing material is then cut by a cutting apparatus 172 into individual shingles 174, into pieces to make laminated shingles, or into suitable lengths for commercial roofing or roll roofing. The roofing material is then collected and packaged.

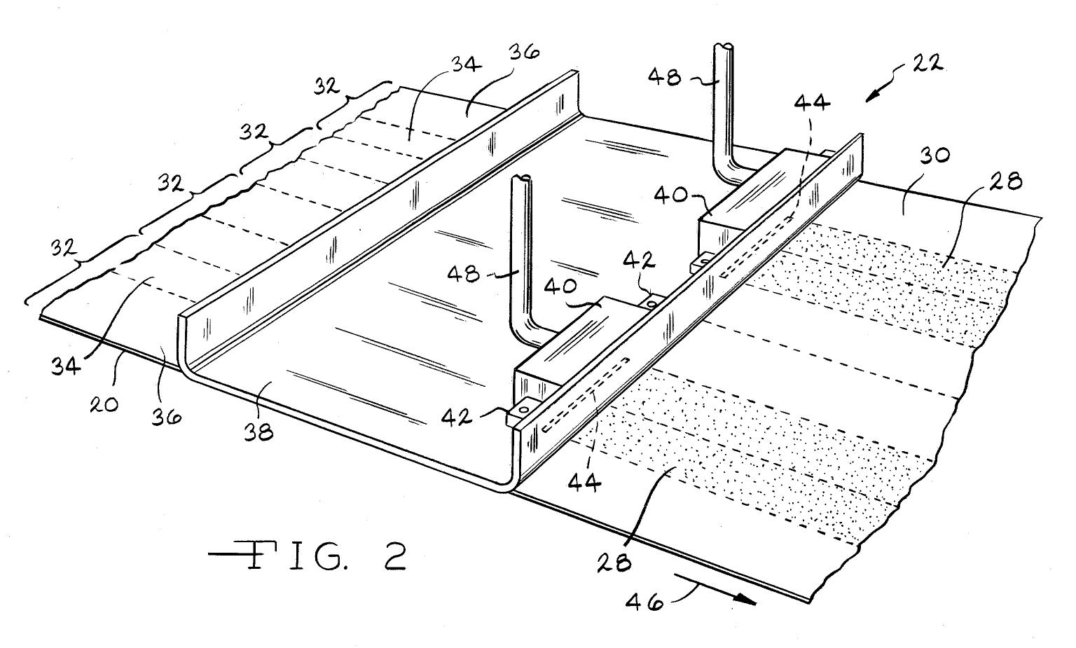

The protective coating can be applied to the upper surface of the asphalt coating by any method suitable for forming a layer that is effective to improve the durability of the roofing material. In a preferred embodiment, the protective coating is applied as a film, which can be a solid, semisolid or molten film. FIG. 2 illustrates an applicator 22 for applying a pair of molten films 28 of protective coating onto the upper surface 30 of the asphalt-coated sheet 20. The sheet can include single or multiple lanes. Four lanes 32 are shown in the illustrated embodiment (indicated by the dotted lines), so that the sheet can be cut into roofing shingles. In the illustrated embodiment, each of the lanes includes a prime portion 34 that is normally exposed to the elements when the roofing material is installed on a roof, and a headlap portion 36 that is normally covered by adjacent shingles when the roofing shingle is installed on the roof. Preferably, the films of protective coating are applied to the prime portions of the sheet, but not to the headlap portions. Application of the protective coating to just the prime portions of the sheet provides improved durability to the portion of the roofing shingle exposed to the elements on a roof, while minimizing the overall cost of the roofing material. However, a film of protective coating can also be applied to cover the entire sheet.

The applicator shown in FIG. 2 includes a support shoe 38 for supporting dies 40. Single or multiple dies can be mounted in openings in the support shoe, and secured by fasteners such as brackets 42. Two dies 40 are shown in the embodiment illustrated at FIG. 2. Each die 40 includes a slot 44 that faces downwardly toward the asphalt coating, and that is oriented transversely to the direction 46 of movement of the sheet. The dies are supplied through heated feed hoses 48 with melted protective coating that is pumped from a storage tank (not shown). The melted protective coating is extruded as a film 28 through the slot of each die onto the upper surface of the asphalt coating. The support shoe prevents the formation of ridges or wakes in the protective coating along the sides of the slot during application of the film.

It was discovered that the rapid movement of the asphalt-coated sheet creates a boundary layer of air on the upper surface of the sheet, and that when the protective coating is applied, the boundary layer can cause the protective coating to be discontinuous across the area of intended application instead of continuous. In a preferred embodiment, the applicator is positioned sufficiently close to the upper surface of the asphalt coating to minimize the boundary layer and thereby significantly reduce discontinuities in the protective coating. Preferably, the protective coating forms a layer that is at least about 90% continuous (not more than 10% open areas), and more preferably it forms a substantially completely continuous and unitary layer. As shown in FIG. 2, the support shoe 38 and dies 40 of the applicator are positioned almost in contact with the upper surface 30 of the asphalt-coated sheet 20. Preferably, the applicator is positioned within about 0.1 inch (0.254 cm) of the upper surface.

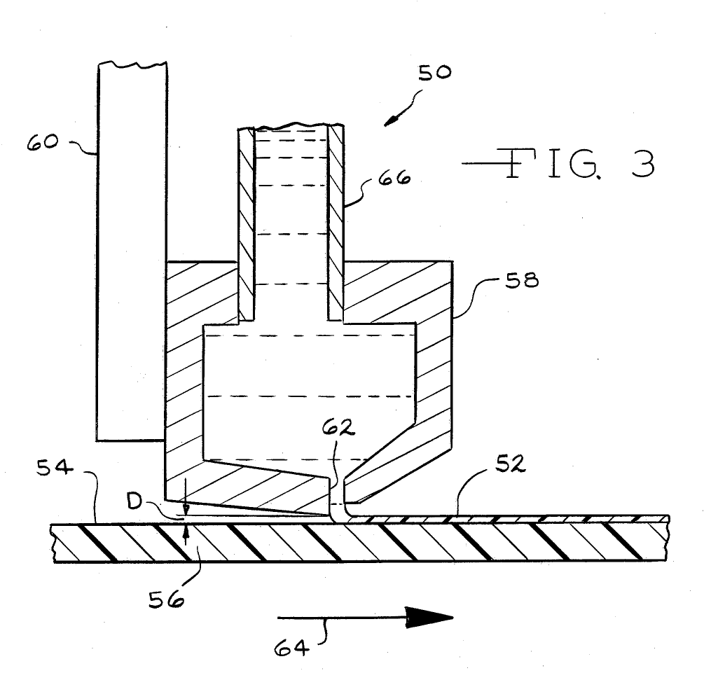

FIG. 3 illustrates another preferred applicator 50 for applying a film 52 of protective coating onto the upper surface 54 of an asphalt-coated sheet 56 according to the invention. A die 58 is mounted on a die mount 60 positioned above the sheet. The die includes a slot 62 that faces downwardly toward the asphalt coating, and that is oriented transversely to the direction 64 of movement of the sheet. The die and slot are positioned a distance D of within about 0.1 inch (0.254 cm) from the upper surface of the sheet. The die is supplied through a heated supply line 66 with melted protective coating that is pumped from a storage tank (not shown). The melted protective coating is extruded through the slot as a film 52 onto the upper surface of the asphalt-coated sheet.

Many other methods can be used for applying the protective coating to the upper surface of the asphalt coating. One method is paying out a previously extruded film of the protective coating material onto the asphalt-coated sheet. Another method is adding protective coating material in particulate form to the upper surface of the asphalt-coated sheet, and then heating the protective coating material to melt it and cause it to flow into a substantially continuous layer. A further method is pre-mixing the protective coating material in particulate form into the asphalt coating, so that the protective coating material melts and phase separates from the asphalt coating when the asphalt coating is heated, to provide a substantially continuous layer on the asphalt coating. Other suitable methods include spraying and roll coating. Preferably, the protective coating is fluid enough when the granules are applied that it flows partially around the granules to adhere them to the coating. In a preferred embodiment, the protective coating is applied immediately after the asphalt coating is applied and immediately before the granules are applied.

Preferably, the protective coating covers at least about 80% of the upper surface of the asphalt coating in the prime portion 34 of the roofing material. More preferably, the protective coating substantially completely covers the upper surface of the asphalt coating in the exposed portion. As shown in FIG. 2, the films of protective coating 28 completely cover the prime (exposed) portions 34 of the roofing material. The protective coating preferably has an average thickness of at least about 1 mil (0.025 mm), more preferably at least about 3 mils (0.076 mm), and most preferably about 5 mils (0.127 mm). However, the protective coating is not so thick that it covers the granules and leaves a glossy appearance on the surface of the roofing material. Preferably, the protective coating has an average thickness of not greater than about 60 mils (1.5 mm). Covering the asphalt coating with the protective coating reduces granule loss.

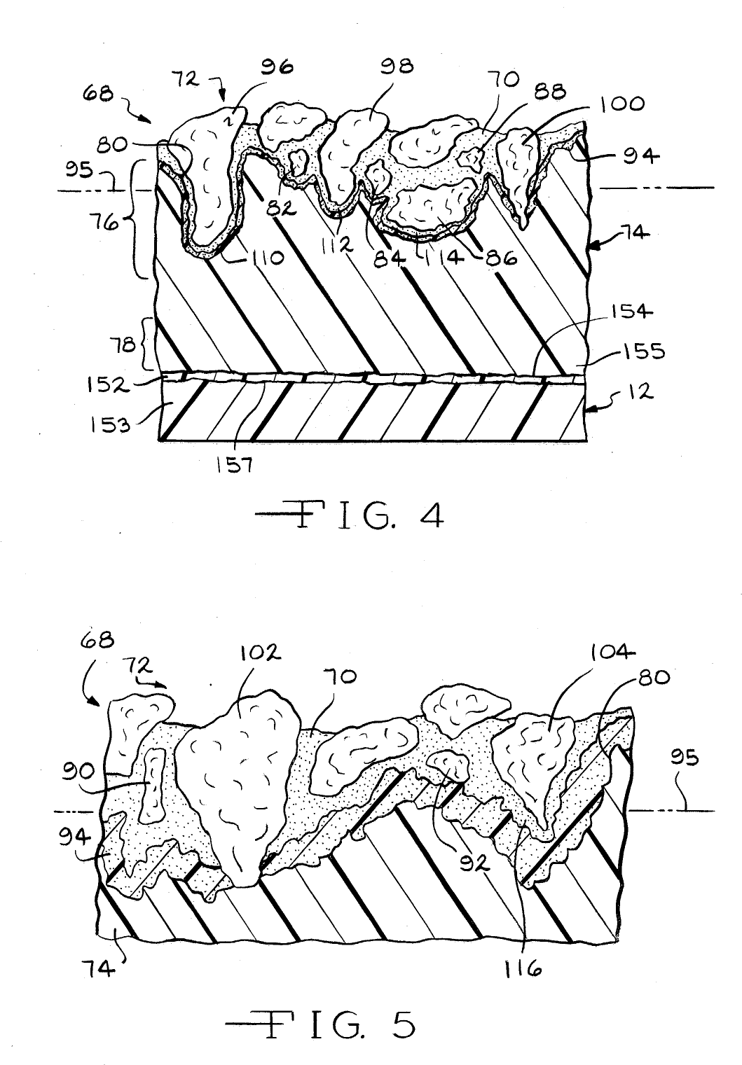

FIGS. 4 and 5 illustrate a roofing material 68 according to the invention with an applied protective coating 70 and a layer of granules 72. The roofing material includes a substrate 12 having an upper surface that is coated with an asphalt coating 74. The asphalt coating includes an upper region 76 that is positioned above the substrate 12 when the roofing material is installed on a roof, and a lower region 78, also positioned above the substrate 12 when the roofing material is installed on a roof. The upper region 76 includes an upper surface 80. The protective coating 70 is adhered to the upper surface 80 of the asphalt coating 74. The surface layer of granules 72 is adhered to the protective coating 70. Although the roofing material 68 illustrated includes an asphalt coating 74 on only the upper surface of the substrate 12, it will be understood that a lower surface of the substrate 12 may also be coated with an asphalt coating.

It is believed that the protective coating improves the adhesion of the granules by several possible different mechanisms. The granules may adhere more strongly to the protective coating than the asphalt coating, because of the different compositions of the protective coating and the asphalt coating. In some embodiments, the protective coating completely envelops a middle layer of granules to adhere the granules to the roofing material. Preferably, from about 0.5% to about 6% of the total granules are enveloped. In FIG. 4, the protective coating 70 completely envelops the granules 82, 84, 86 and 88, and in FIG. 5, the protective coating 70 completely envelops the granules 90 and 92.

The protective coating also adheres strongly to the asphalt coating. In the illustrated embodiment, an interphase region 94 comprises a portion of the protective coating 70 which has been intermingled with a portion of the asphalt coating 74 by melting and mixing, because of the partial miscibility of the protective coating with the asphalt coating. The intermingling strongly adheres the protective coating to the asphalt coating. Some protective coating materials are miscible with the asphalt coating, and others are not miscible. In some embodiments of the invention, the protective coating adheres strongly to the asphalt coating without such intermingling.

As shown in the drawings, the granules 72 have been pressed down into the protective coating 70. Usually, at least a portion of the granules penetrates the asphalt coating 74. “Penetrate” means that a granule extends past an asphalt coating line 95 which is an average upper surface 80 of the asphalt coating 74. In FIG. 4, the granules 96, 98, 84, 86 and 100 penetrate the asphalt coating, and in FIG. 5, the granules 90, 102 and 104 penetrate the asphalt coating. In some embodiments of the invention, a substantially continuous layer of the protective coating is maintained between the asphalt coating and the granules that penetrate the asphalt coating. In FIG. 4, layers 110, 112 and 114 of the protective coating are maintained between the granules 96, 98 and 86 and the asphalt coating, and in FIG. 5, a layer 116 is maintained between the granule 104 and the asphalt coating. It was believed beforehand that when a granule was pressed through the layer of protective coating into the asphalt coating, the protective coating layer might not be maintained between the granule and the asphalt coating. Preferably, a substantially continuous layer of the protective coating is maintained between the asphalt coating and at least about 30% of the granules that penetrate the asphalt coating. The continuous layer of protective coating around the granules increases the adhesion of the granules to the roofing material.

Additionally, the protective coating may provide a seal to prevent outside moisture from flowing around the granules to the asphalt coating. This may help to prevent degradation of the roofing material. In FIG. 4, the protective coating provides a seal to prevent moisture from flowing around the granule 100 to the asphalt coating, even though the granule penetrates the asphalt coating. The protective coating forms a tight seal completely around the perimeter of the granule. Similarly, in FIG. 5, the protective coating provides a seal around the granule 102.

Referring again to FIG. 4, the substrate 12 is bonded to the lower region 78 of the asphalt coating 74. It has been discovered that bonding the substrate 12 to the lower region of the asphalt coating 74 provides an unexpected improvement in resistance to a variety of impacts.

Preferably, the roofing material of the present invention includes a strong bond between the substrate 12 and the asphalt coating 74, to ensure that the substrate 12 does not separate from the asphalt coating 74. If the substrate 12 separates from the asphalt coating 74, it is not effective to dissipate the energy of an impact on the roofing material. The strong bond is achieved by fusing the substrate 12 and the asphalt coating 74. Specifically, a portion of the substrate 12 and of the asphalt coating 74 are intermingled by melting, thereby fusing the substrate 12 and the asphalt coating 74. “Intermingled” includes any type of physical and/or chemical intermingling of the substrate 12 and the asphalt coating 74, to provide a strong mechanical and/or chemical bond.

The roofing material 68 includes an interphase region 152 where intermingling by melting has occurred between a portion of the substrate 12 and a portion of the lower region 78 of the asphalt coating 74, because of the partial miscibility of the melted substrate 12 and the melted asphalt coating 74. The interphase region 152 is usually a non-homogenous region including various concentrations of melted asphalt coating 74, partially or completely melted substrate 12, and mixtures of melted asphalt coating 74 and melted web. The interphase region 152 is a different composition from either a remaining portion 153 of the substrate 12 or a remaining portion 155 of the lower region 78 of the asphalt coating 74. Thus, the intermingling can include varied degrees of mixing between the substrate 12 and the asphalt coating 74. In the illustrated embodiment, the intermingling also includes an irregular interface 154 or boundary between the interphase region 152 and the modified asphalt coating 74 155. The irregular interface 154 is comprised of peaks and valleys that have resulted from interpenetration between the interphase region and the modified asphalt coating 74. The irregular interface enhances the bond between the substrate 12 and the modified asphalt coating 74. A portion 153 of the substrate 12 may have no intermingling with the asphalt coating 74, thereby forming an interface 157 between the interphase region 152 and the portion 153 of the substrate 12.

The protective coating 70 can be any material suitable for forming a layer that is effective to improve the durability of the roofing material, such as any type of thermoplastic, thermoset, or asphalt-based polymeric materials. In a preferred embodiment, the protective coating functions as an adhesive. Similarly, the adhesive can include any type of thermoplastic, thermoset, or asphalt-based adhesive that is effective to adhere the granules to the asphalt coating. Some examples of suitable hot-melt adhesives include ethylene-vinyl acetate copolymers, ethylene-ethyl acetate copolymers, ethylene-n-butylacrylate polymers, ethylene-methacrylate polymers, styrene-isoprene-styrene block or graft copolymers, styrene-butadiene-styrene block or graft copolymers, other styrene-containing block or graft copolymers, polyamide terpolymers, hydrocarbon rubbers, polyethylenes, polyesters, polyurethanes, siloxanes, and mixtures and/or combinations of these materials. Preferred adhesives for use in the invention are flexible ethylene-vinyl acetate copolymers, ethylene-vinyl acetate copolymers modified with styrene-butadiene-styrene block copolymers, and tackified polyethylenes. Preferably, the adhesive is selected so that it adheres to the roofing granules predominantly by polar bonding. For example, ethylene-vinyl acetate copolymers adhere to conventional coated (painted) roofing granules predominantly by polar bonding. The adhesive can be modified with materials such as styrene butadiene polymers, polyolefin polymers, styrene isoprene polymers, petroleum derived tackifying resins, rosin derived tackifying resins, terpene derived tackifying resins, paraffin waxes and oils, microcrystalline waxes and oils, and napthanic waxes and oils.

A stabilizer can be added to the protective coating 70 to tailor the protective coating to specialized conditions, such as extreme exposures of ultraviolet light, solar radiation, and/or temperature. The protective coating can also contain other additives such as algicides, fungicides, or pigments.

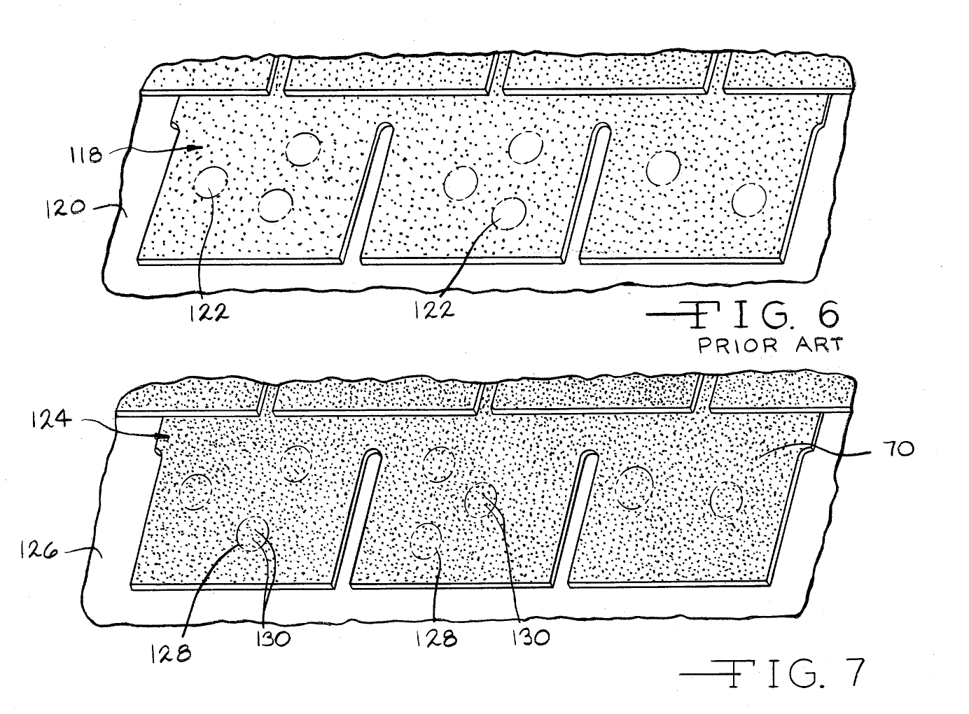

FIGS. 6 and 7 illustrate an effect of the thermoplastic substrate 12, modified asphalt coating 74, and the protective coating 70 in providing improved durability to a roofing shingle, and particularly, the improved retention of granules 72. FIG. 6 shows a prior art roofing shingle 118, without the protective coating, installed on a roof 120. The roofing shingle has been subjected to impacts at several areas 122, creating depressions in those areas. After a period of time, the granules on the impacted areas lose their adhesion and they are lost from the roofing material. The loss of granules leaves the asphalt coating in the impacted areas exposed to the elements. The exposed asphalt coating becomes eroded from the effects of weathering on the asphalt coating. The resulting roofing shingle has an unattractive appearance and, ultimately, will no longer be effective to protect the building.

In contrast, FIG. 7 shows a roofing shingle 124 with the thermoplastic substrate, modified asphalt coating, and the protective coating 70 according to the present invention, installed on a roof 126. The roofing shingle has also been subjected to impacts at several areas 128, creating depressions in those areas. Unlike the prior art roofing shingle, the roofing shingle with the protective coating retains the granules 130 in the impacted areas after the same period of time. The asphalt coating in those areas is protected by the granules, so that the roofing shingle maintains its effectiveness and attractive appearance. Additionally, the thermoplastic substrate provides the roofing material with improved impact resistance to a variety of impacts. The improved impact resistance eliminates the occurrence of punctures or tears in the roofing material caused by impacts, and thereby maintains the integrity of the roofing material. The roofing material thereby retains its ability to protect the building from the elements so that, for example, water leaks are avoided.

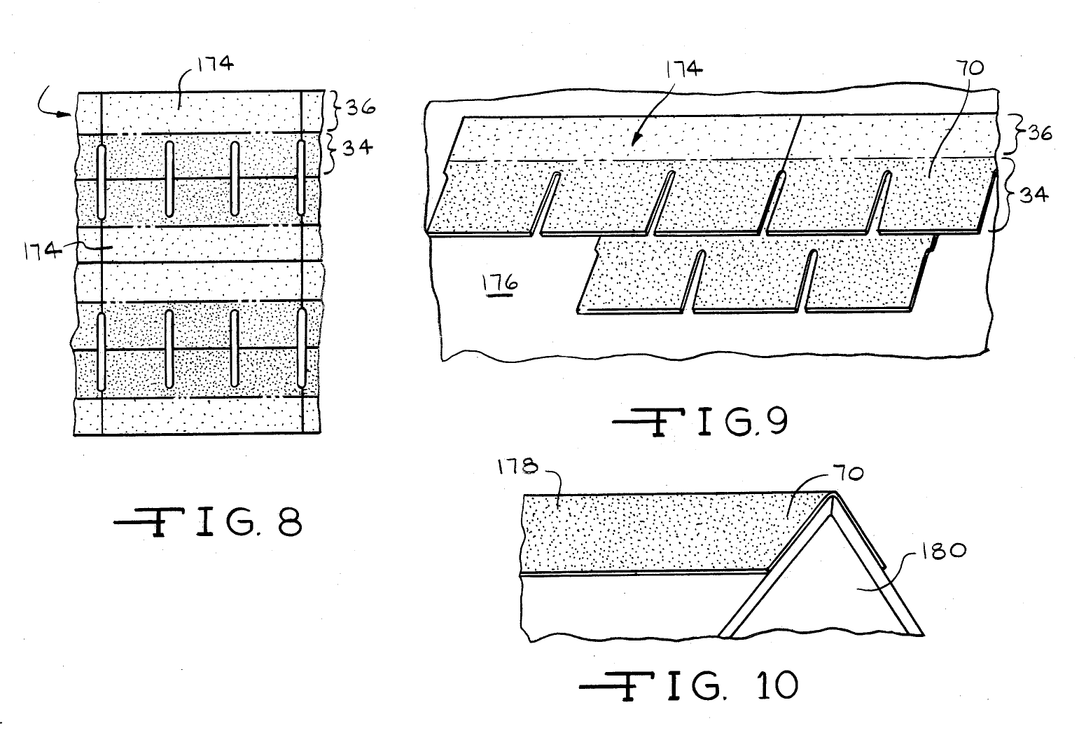

FIG. 8 illustrates the sheet 20 of roofing material after it has been cut into three-tab roofing shingles 174 but before separating the shingles from the sheet. FIG. 9 illustrates several roofing shingles 174 installed on a roof 176. As shown in FIGS. 8 and 9, each roofing shingle includes a prime (exposed) portion 34 and a headlap (covered) portion 36. As indicated by the areas of darker shading, the protective coating 70 is applied to the prime portion but not the headlap portion of each shingle.

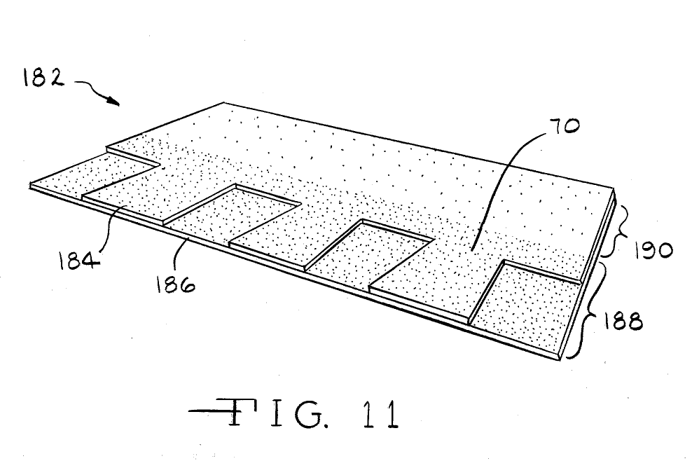

FIG. 10 illustrates a hip and ridge roofing shingle 178 according to the invention installed on the ridge 180 of a roof. The protective coating 70 and web are applied to the entire shingle because the entire shingle is exposed to the elements on the roof.

FIG. 11 illustrates a laminated roofing shingle 182 according to the invention. The laminated shingle is comprised of two pieces of roofing material, an overlay 184 and an underlay 186, which are secured together by adhesive or other means. The laminated shingle includes a prime portion 188 and a headlap portion 190. As indicated by the area of darker shading, the protective coating 70 is preferably applied to the prime portion but not the headlap portion of the shingle. Furthermore, although shown as a full underlay, the laminated shingle may have an underlay having a height less than the entire height of the overlay. Similarly, multiple layers of laminates may be used, such as a trilaminate, and the adhesive 70 is preferably used at least to retain the granules in the exposed portion of each layer. In an alternative embodiment, the protective coating 70 may be applied only to the exposed areas of the underlay sheet of the laminated shingle, such that the exposed portion of the underlay between the tabs of the overlay includes the coating 70, but the portions under the tabs may be substantially free of adhesive 70.

It should be understood that, although the improved durability provided by the protective coating is mainly described in terms of reduced granule loss, the protective coating also provides many other advantages. For example, the protective coating may prevent or reduce fracturing of the asphalt coating resulting from impacts on the roofing material. The improved durability provided by the protective coating may allow increased flexibility in selecting the composition and materials of the roofing material. The protective coating may provide a moisture barrier that reduces blistering potential and algal growth. The protective coating may reduce cracking of shingles on a roof, and may partially heal any cracks that occur. The protective coating may provide a more uniform surface that may reduce shading. Additionally, the protective coating may reduce sticking within a bundle of shingles. Other advantages are also envisioned for the protective coating. Handleability, walkability and scuffing performance are maintained or improved by the addition of the protective coating.

Although the improved impact resistance provided by the substrate is mainly described in terms of resistance to impact from hailstones, the substrate may also provide improved resistance to other types of impact on the roofing material, or to improve handling, appearance and weatherability.

The roofing material of the invention includes any type of roofing material, such as shingles with or without tabs, laminated shingles of various designs, commercial roofing, and roll roofing. The invention is intended to be applicable to any current or future designs of roofing materials.

Impact Resistance Testing:

The improved impact resistance of the roofing materials of the present invention is demonstrated by the use of a standard method, UL 2218, “Standard for Impact Resistance of Prepared Roof Covering Materials,” Underwriters Laboratories, May 31, 1996. In this method, the roofing material is secured to a test deck, and a steel ball is dropped vertically through a tube onto the upper surface of the roofing material. The roofing material can be tested at four different impact force levels: Class 1 (lowest impact force) through Class 4 (highest impact force). The force of impact in the different classes is varied by changing the diameter and weight of the steel ball, and the distance the ball is dropped. For example, the Class 1 test uses a steel ball having a diameter of 1.25 inches (32 mm) weighing 0.28 pounds (127 g) and dropped a distance of 12 feet (3.7 m), while the Class 4 test uses a steel ball having a diameter of 2 inches (51 mm) weighing 1.15 pounds (521 g) and dropped a distance of 20 feet (6.1 m).

After the impact, the roofing material is inverted and bent over a mandrel in both the machine and cross directions, and the lower surface of the roofing material is examined visually for any evidence of an opening or tear. A 5× magnification device may be used to facilitate the examination of the roofing material. If no evidence of an opening is found, the roofing material passes the impact resistance test at the UL 2218 class tested. Preferably, a roofing material having a thermoplastic substrate according to the present invention has an increased impact resistance of at least two UL 2218 classes when compared with the same roofing material with a conventional shingle mat. More preferably, the roofing material meets a UL 2218 Class 4 impact resistance standard.

UL 2218 Granule Adhesion Testing:

Roofing shingles including different types of protective coating according to the invention were tested for granule adhesion compared to the same kind of roofing shingle without the protective coating (the “control” shingle). Three different adhesives were tested as the protective coating: flexible ethylene-vinyl acetate copolymers (Reynco 52-057, Reynolds Co., Greenville, S.C.); ethylene-vinyl acetate copolymers modified with styrene-butadiene-styrene block copolymers (Reynco 52-146); and tackified polyethylene (Reynco 52-115). The adhesive was applied as a film 5 mils (0.13 mm) thick on a three tab shingle in a standard manufacturing facility. The adhesive completely covered the prime portion of the roofing shingle.

The shingles were subjected to accelerated testing to simulate the effects of weathering and hail impact. The shingles were subjected to 60 days exposure of alternating cycles of concentrated solar radiation and water spray. The shingles were then cooled to 14 degrees F. (−10 degrees C.), and a test coupon from each shingle was subjected to a UL 2218 Class 4 impact, wherein a steel ball having a diameter of 2 inches (51 mm) and weighing 1.15 pounds (521 g) is dropped a distance of 20 feet onto the test coupon. A circle 1 inch (2.4 cm) in diameter at the area of impact was then inspected for the area percentage of granules lost. The control shingle lost about 44% of the granules from the area of impact. In contrast, the shingle coated with the ethylene-vinyl acetate copolymers lost only about 3% of the granules, the shingle coated with the SBS-modified ethylene-vinyl acetate copolymers lost only about 5% of the granules, and the shingle coated with the polyethylene lost only about 2% of the granules.

Water Spray Granule Adhesion Test

In addition to being testing in accordance with UL 2218, the shingles were subjected to a water spray granule adhesion test to determine how well granules are adhered to the surface of the shingle after 15 cycles with a water spray. The shingles were heated to 176 degrees F. (80 degrees C.), in both dry and simulated storm-wet conditions. The shingles were then subjected to a water spray at time intervals ranging from about 0 to about 80 days.

Each test cycle consisted of passing a spray of water having a pressure within the range of from about 780 psi to about 820 psi twice over the same surface area (i.e. passing the water spray over the length of the shingle in one direction, and then in the opposite direction). Each cycle had a duration of about one second. The control shingle lost an average of about 2.20 grams of granules. In contrast, the shingle coated with the ethylene-vinyl acetate copolymers lost an average of only about 1.21 grams of granules.

In a further embodiment according to the present invention, a modified asphalt as described above is used in combination with the protective coating 70, but without the substrate. In such an embodiment, the modified asphalt is selected to achieve the strength and impact properties, and the protective coating 70 serves primarily to retain the granules, but may be formulated to improve the strength and/or impact properties of the roofing material. In a further alternative embodiment, a web is provided on the bottom of such a roofing product to prevent sticking of the product, and/or to improve impact, tensile, or other properties. In yet another embodiment, the protective coating 70 is replaced with an aesthetic web, and no granules are preferably used. The top web may comprise a metal film or a film to simulate granules, or any other such material to provide an aesthetic top surface.

The principle and mode of operation of this invention have been described in its preferred embodiments. However, it should be noted that this invention may be practiced otherwise than as specifically illustrated and described without departing from its scope.

What is claimed is:

1. An asphalt-based roofing material comprising:
a thermoplastic substrate coated with an asphalt coating, the asphalt coating including an upper surface that is positioned above the substrate when the roofing material is installed on a roof, and a lower region that is positioned below the substrate when the roofing material is installed on the roof, the substrate comprising materials having an ultimate tensile elongation of greater than about six percent;
a protective coating adhered to the upper surface of the asphalt coating; and
a surface layer of granules adhered to the protective coating.

2. The roofing material of claim 1 wherein the substrate is a film selected from the group consisting essentially of polyester, polyamide imide, glass reinforced nylon, and polybutylene terephthalate.

3. The roofing material of claim 2 wherein the substrate is a polyester film.

4. The roofing material of claim 1 wherein the substrate is a film and has an average thickness within the range of about 0.005 inches to about 0.030 inches.

5. The roofing material of claim 1, wherein the thermoplastic substrate has sufficient strength such that, when tested under impact resistance test UL 2218, the roofing material exhibits an impact resistance improvement of at least two UL 2218 classes compared with the same roofing material without the thermoplastic substrate.

6. The roofing material of claim 5 which meets a UL 2218 Class 4 impact resistance standard.

7. The roofing material of claim 1 which, after aging by 60 days exposure to alternating cycles of concentrated solar radiation and water spray, then cooled to 14 degrees F. (−10 degrees C.) and subjected to a UL 2218 Class 4 impact, exhibits improved adhesion of the granules as measured by at least about 30% less granule loss in the area of impact compared with the same roofing material without the protective coating.

8. The roofing material of claim 1 including a portion that is normally exposed when the roofing material is installed on a roof, in which the protective coating covers at least about 80% of the upper surface of the asphalt coating in the exposed portion of the roofing material.

9. The roofing material of claim 1 wherein the protective coating has an average thickness of at least about 1 mil (0.025 mm) and covering at least about 80% of the upper surface of the asphalt coating in the exposed portion of the roofing material.

10. The roofing material of claim 1 in which the protective coating comprises an adhesive.

11. The roofing material of claim 10 in which the adhesive is selected so that the granules adhere to the adhesive predominantly by polar bonding.

12. The roofing material of claim 10 in which the adhesive is selected from the group consisting of ethylene-vinyl acetate copolymers, ethylene-vinyl acetate copolymers modified with styrene-butadiene-styrene block copolymers, ethylene-ethyl acetate copolymers, ethylene-n-butylacrylate polymers, ethylene-methacrylate polymers, styrene-isoprene-styrene block or graft copolymers, styrene-butadiene-styrene block or graft copolymers, other styrene-containing block or graft copolymers, polyamide terpolymers, hydrocarbon rubbers, polyethylenes, polyesters, polyurethanes, siloxanes, and mixtures of these materials.

13. The roofing material of claim 1 wherein the asphalt coating is a rubber-modified asphalt.

14. The roofing material of claim 1 wherein the asphalt coating is a polymer-modified asphalt.

15. The roofing material of claim 1 wherein the substrate forms a lower surface of the roofing material, the roofing material including an asphalt coating that is positioned above the substrate when the roofing material is installed on a roof.

16. The roofing material of claim 1 wherein at least a portion of the surface layer of granules penetrate the asphalt coating, the protective coating providing a seal to prevent outside moisture from flowing around the granules to the asphalt coating, and wherein the protective coating completely envelops a number of the granules within the range of from about 0.5% to about 6% of the total granules.

17. The roofing material of claim 1, wherein said protective coating comprises a substantially continuous layer.

18. The roofing material of claim 17, wherein the protective coating comprises one or more solidified film strips applied onto the upper surface of the asphalt coating, the strips being melted to form the continuous layer.

19. The roofing material of claim 17, wherein the protective coating comprises a particulate material applied onto the upper surface of the asphalt coating, the particulate material being melted to form the continuous layer.

20. The roofing material of claim 1 wherein the asphalt coating applied to the upper surface of the substrate is selected from a group consisting of a rubber-modified asphalt and a polymer-modified asphalt.

21. The roofing material of claim 1, further comprising a web provided on a bottom surface of an asphalt coating provided on the lower region of the roofing material.

22. An asphalt-based roofing material including a portion that is normally exposed when the roofing material is installed on a roof, the roofing material comprising:
a thermoplastic substrate coated with an asphalt coating, the asphalt coating positioned above the substrate when the roofing material is installed on a roof, the substrate comprising materials having an ultimate tensile elongation of greater than about six percent;
a protective coating adhered to an upper surface of the asphalt coating, the protective coating comprising a continuous layer covering at least about 80% of the upper surface of the asphalt coating in the exposed portion of the roofing material; and
a surface layer of granules adhered to the protective coating, wherein at least a portion of the granules penetrate the asphalt coating, the protective coating providing a seal to prevent outside moisture from flowing around the granules to the asphalt coating, and wherein the protective coating completely envelops a number of the granules within the range of from about 0.5% to about 6% of the total granules.

23. A method of manufacturing an asphalt-based roofing material, comprising the steps of:
coating a thermoplastic substrate with an asphalt coating, the asphalt coating including an upper surface that is positioned above the substrate when the roofing material is installed on a roof, the substrate comprising materials having an ultimate tensile elongation of greater than about six percent;
applying a protective coating to the upper surface of the asphalt coating; and
applying a surface layer of granules to the protective coating.

24. The method of claim 23, further comprising the step of coating a lower surface of the substrate with an asphalt coating, forming a lower region that is positioned below the substrate when the roofing material is installed on the roof.

25. The method of claim 24 wherein the substrate is selected from the group consisting essentially of polyester, polyamide imide, glass reinforced nylon, and polybutylene terephthalate.

26. The method of claim 25 wherein the substrate comprises a polyester film.

27. The method of claim 23 wherein the asphalt coating comprises a rubber-modified asphalt.

28. The method of claim 23 wherein the asphalt coating is a polymer-modified asphalt.

29. The method of claim 23 in which the roofing material includes a portion that is normally exposed when the roofing material is installed on the roof, and in which the protective coating is applied to cover at least about 80% of the upper surface of the asphalt coating in the exposed portion of the roofing material.

30. The method of claim 29 in which the protective coating is applied to cover substantially all of the upper surface of the asphalt coating in the exposed portion of the roofing material.

31. The method of claim 23 in which the step of applying the protective coating comprises applying an adhesive.

32 The method of claim 23in which the step of applying the protective coating comprises providing a film of the protective coating and applying the film to the upper surface of the asphalt coating.

33 The method of claim 23, in which the substrate forms a lower surface of the roofing material, and the step of coating the substrate with an asphalt coating includes applying the asphalt coating to an upper surface of the substrate, the asphalt coating being positioned above the substrate when the roofing material is installed on a roof.

34. An asphalt-based roofing material comprising: a thermoplastic substrate coated with an asphalt coating, the asphalt coating including an upper surface that is positioned above the substrate when the roofing material is installed on a roof, and a lower region that is positioned below the substrate when the roofing material is installed on the roof, the substrate comprising materials having an ultimate tensile elongation of greater than about six percent; and
a surface layer of granules adhered to the upper surface of the asphalt coating.

35. An asphalt-based roofing material comprising:
a thermoplastic substrate coated with an asphalt coating, the asphalt coating including an upper surface that is positioned above the substrate when the roofing material is installed on a roof, and a lower region that is positioned below the substrate when the roofing material is installed on the roof, the substrate comprising materials having an ultimate tensile elongation of greater than about six percent; and
a surface layer of granules adhered to the upper surface of the asphalt coating.

35. An asphalt-based roofing material comprising:
a layer of modified asphalt selected from the group consisting of a rubber-modified asphalt and a polymer-modified asphalt;
a protective coating adhered to the upper surface of the asphalt coating;
a surface layer of granules adhered to the protective coating; and
said roofing material meeting a UL 2218 Class 4 impact resistance standard.

36. A roofing material according to claim 35, further comprising a web provided on a bottom surface of said modified asphalt.

37. A roofing material according to claim 36, wherein said web has an ultimate tensile elongation of greater than about six percent.
